(19) United States
(12) Patent Application Publication
(10) Pub. No.: US 2011/0210654 A1
(43) Pub. Date: Sep. 1, 2011

(54) TIPPABLE SHELF FOR TELECOMMUNICATIONS RACK

(75) Inventors: Jennifer Edison Zatz, Denver, CO (US); Andrew Bruno, Thornton, CO (US); Stephen Sattler, Castle Rock, CO (US)

(73) Assignee: Qwest Communications International Inc., Denver, CO (US)

(21) Appl. No.: 12/714,343

(22) Filed: Feb. 26, 2010

(51) Int. Cl. A47B 57/04; A47B 81/00; B23P 11/00

(52) U.S. Cl. 312/327; 211/26; 29/428

(57) ABSTRACT

A telecommunications cabinet systems and methods provide a cabinet enclosure coupled with a tippable shelf assembly. Exemplary tippable shelf assemblies include a support mechanism having a mounting connection coupled with the telecommunication cabinet, and a pivoting tray mechanism having a component connection attached with a telecommunications or electronics component. The pivoting tray mechanism is pivotably and translatably coupled with the support mechanism and provides access to the telecommunications component during an installation or maintenance procedure.

### CROSS-REFERENCES TO RELATED APPLICATIONS

This application is related to U.S. patent application Ser. No. 11/780,045 filed Jul. 19, 2007, the entire content of which is incorporated herein by reference for all purposes.

### BACKGROUND OF THE INVENTION

Embodiments of the present invention relate to protective containers for electronic equipment, and in particular to enclosure systems and methods for storing electronic components on tippable shelf assemblies.

Currently available protective containers for electronic equipment generally include an interior rack assembly enclosed by an outer cabinet. The interior rack assembly, which supports the various telecommunications components, has a series of horizontal shelves mounted upon one or more vertical rails.

Although these and other proposed protective containers may provide beneficial solutions for storing and protecting electronic equipment, still further advances would be desirable. For example, there continues to be a need for improved protective enclosure systems and methods that provide shielding to standard telecommunications rack and device components, while utilizing minimal floor space or meeting other spatial dimension requirements for a telecommunications room or space. Embodiments of the present invention provide solutions that address the problems which may be associated with known techniques, and hence provide answers to at least some of these outstanding needs.

### BRIEF SUMMARY OF THE INVENTION

Embodiments of the present invention encompass systems and methods for storing and protecting electronics equipment in a compact space in an efficient and easily accessible manner. An exemplary protective container includes an outer cabinet, an interior rack assembly, and a sliding shelf system coupled with the rack assembly. In operation, the user can pull out a shelf which supports an electronics component, and swing the shelf down to realize enhanced access to rear equipment connections and other features. Such sliding shelf assemblies are particularly well suited for providing convenient access to electronic components having large depth dimensions, and to components which are housed in compact spaces. Relatedly, tippable shelf mechanisms can include support shelves which slide on horizontal rails and that pivot in a downward direction so as to allow an equipment technician to easily and efficiently install, remove, provide maintenance to, or otherwise handle the electronic equipment. For example, the technician can slide a shelf out in a horizontal direction, and then tip the shelf downward into a vertical orientation, thus establishing convenient access to the rear of the equipment for easy wiring and effective cable management. After the desired maintenance is complete, the shelf can be tipped back to a horizontal orientation, and returned to the original position. Such pivoting shelf embodiments may particularly well suited for use in HEMP protection systems such as those described in previously incorporated U.S. Ser. No. 11/780,045 filed Jul. 19, 2007.

In one aspect, embodiments of the present invention encompass telecommunications cabinet systems that include a cabinet enclosure and a tippable shelf assembly. The tippable shelf assembly can include a support mechanism having a mounting connection for coupling with the telecommunication cabinet, and a pivoting tray mechanism having a component connection for attachment with a telecommunications component. The pivoting tray mechanism can be pivotably and translatably coupled with the support mechanism. Further, the mounting connection of the support mechanism of the tippable shelf assembly can be coupled with the cabinet enclosure. In some cases, the cabinet enclosure includes a mounting rail, and the mounting connection of the support mechanism of the tippable shelf assembly is coupled with the mounting rail. Optionally, the mounting rail can be disposed in a vertical orientation. In some cases, the support mechanism includes a support rail having a translation slot, and the pivoting tray mechanism includes a pin engaged with the support rail translation slot. In some cases, the support mechanism includes a support locking member, and the pivoting tray mechanism includes a pivoting tray locking member that locks with the support locking member. Optionally, the support locking member can include a locking aperture, and the pivoting tray locking member can include a locking pin. In some instances, the pivoting tray mechanism may include a rail engagement flange, and the support mechanism may include a support rail that supports the rail engagement flange. The support rail of the support mechanism may include a support locking member, and the pivoting tray mechanism may include a pivoting tray locking member that locks with the support locking member.

In another aspect, embodiments of the present invention encompass a tippable shelf assembly for use in a telecommunication cabinet. The shelf assembly may include, for example, a support mechanism having a mounting connection for coupling with the telecommunication cabinet, and a pivoting tray mechanism having a component connection for attachment with a telecommunications component. In some cases, the pivoting tray mechanism is pivotably and translatably coupled with the support mechanism. Optionally, the support mechanism includes a support rail having a translation slot, and the pivoting tray mechanism includes a pin engaged with the support rail translation slot. According to some embodiments, the support mechanism includes a support locking member, and the pivoting tray mechanism includes a pivoting tray locking member that locks with the support locking member. Optionally, the support locking member includes a locking aperture, and the pivoting tray locking member includes a locking pin. The pivoting tray mechanism may include a rail engagement flange, and the support mechanism may include a support rail that supports the rail engagement flange. In some cases, the support rail of the support mechanism includes a support locking member, and the pivoting tray mechanism includes a pivoting tray locking member that locks with the support locking member.

In yet another aspect, embodiments of the present invention encompass a method of installing a telecommunications component in a telecommunications cabinet system. The method may include positioning a tippable shelf assembly in an enclosure of the telecommunications cabinet system. The tippable shelf assembly may include a support mechanism having a mounting connection for coupling with the telecommunication cabinet, and a pivoting tray mechanism having a component connection for attachment with a telecommunications component. The pivoting tray mechanism can be pivotably and translatably coupled with the support mechanism. The method may also include coupling the mounting connection of the tippable shelf assembly support mechanism with the telecommunication cabinet, and coupling the component connection of the pivoting tray mechanism with the telecommunications component. In some cases, the step of coupling the mounting connection of the tippable shelf assembly support mechanism with the telecommunication cabinet includes coupling the mounting connection with a vertical mounting rail of the telecommunication cabinet.

In still a further aspect, embodiments of the present invention encompass methods of accessing a telecommunications component stored in a telecommunications cabinet. Such methods may include translating a pivoting tray mechanism relative to a support mechanism toward an opening of the telecommunications cabinet. The pivoting tray mechanism can be pivotably and translatably coupled with the support mechanism, the support mechanism can be coupled with the telecommunications cabinet, and the telecommunications component can be coupled with the pivoting tray mechanism. Methods may also include tipping an anterior portion of the pivoting tray mechanism in a downward direction, and accessing a portion of the telecommunications component. According to some embodiments, the pivoting tray mechanism includes a pin and the support mechanism includes a support rail having a translation slot, and the step of translating the pivoting tray mechanism includes translating the pin of the pivoting tray mechanism within the translation slot of the support rail. In some cases, the pivoting tray mechanism includes a pin and the support mechanism includes a support rail having a translation slot, and the step of tipping the anterior portion of the tray mechanism includes rotating the pin of the pivoting tray mechanism within the translation slot of the support rail. In some cases, the support mechanism includes a support locking member, the pivoting tray mechanism includes a pivoting tray locking member that locks with the support locking member, and the method further includes unlocking the pivoting tray locking member from the support locking member.

For a fuller understanding of the nature and advantages of the present invention, reference should be had to the ensuing detailed description taken in conjunction with the accompanying drawings.

### BRIEF DESCRIPTION OF THE DRAWINGS

FIG. 1 provides a perspective view of a shelf assembly according to embodiments of the present invention.

FIG. 2 provides a side view of a shelf assembly according to embodiments of the present invention.

FIG. 3 provides a top view of a shelf assembly according to embodiments of the present invention.

FIG. 4 provides a perspective view of aspects of a shelf assembly according to embodiments of the present invention.

FIG. 5 illustrates a front view of aspects of a shelf assembly according to embodiments of the present invention.

FIG. 6 shows aspects of a shelf assembly according to embodiments of the present invention.

FIG. 7 shows aspects of a shelf assembly according to embodiments of the present invention.

FIG. 8 shows aspects of a shelf assembly according to embodiments of the present invention.

### DETAILED DESCRIPTION OF THE INVENTION

Embodiments of the present invention encompass systems and methods for storing electronics equipment on tippable shelf assemblies. Such techniques can provide a technician or equipment handler with improved access to the rear section of the electronic equipment. In use, the shelf holding the electronic components is pulled forward on slides or rails. When the slides are full extended, the shelf can be pivoted or tipped forward, for example from a horizontal orientation to a vertical orientation, or about 90 degrees, so that the technician can have access to the back panel of the component on the shelf. Optionally, the shelf may be locked in the raised or horizontal position, or in the lowered or vertical position.

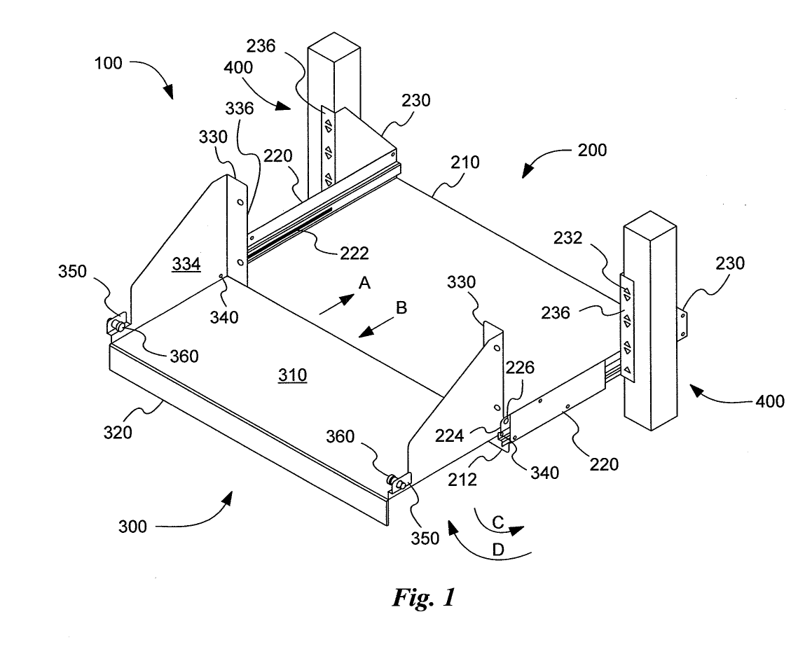

Turning now to the drawings, FIG. 1 illustrates aspects of a shelf assembly 100 according to embodiments of the present invention. Shelf assembly 100 includes a support mechanism 200 in operative association with a pivoting tray mechanism 300. Support mechanism 200 is typically coupled with one or more vertical mounting rails 400. As shown here, support mechanism 200 may include a shelf 210 having an anterior lip 212, support rails 220, and mounting connections 230 having a front plate 236. As shown here, a support rail 220 can be coupled with a vertical mounting rail 400, or another component of a protective container, via a mounting connection 230. A support rail 220 can include a translation slot 222, a tray engagement flange 224, and a locking aperture 226. A mounting connection 230 may include a series of apertures 232 or connecting mechanisms for coupling with a vertical mounting rail. For example, a screw or fastener may be inserted into an aperture 232 so as to fix or secure mounting connection 230 relative to mounting rail 400. In some cases, mounting connection 230 is directly attached with mounting rail 400.

Pivoting tray mechanism 300 can include a component tray 310, an anterior lip or handle 320, component connections 330 having side plates 334 and rear plates 336, pins 340, rail engagement flanges 350, and locking pins 360. In use, tray mechanism 300 can translate relative to support mechanism 200. For example, tray mechanism 300 can slide toward a posterior location as indicted by arrow A. Similarly, tray mechanism 300 can slide toward an anterior location as indicated by arrow B. Optionally, a user or operator can effect such translation by grasping and either pulling or pushing on handle 320. During translation, pin 340 can slide along and within translation slot 222. In the embodiment depicted in FIG. 1, tray mechanism 300 is shown in an extended position. When in an extended position, tray mechanism can pivot relative to support mechanism 200. For example, tray mechanism 300 can tip or rotate downward toward a vertical orientation, as indicated by arrow C. Similarly, tray mechanism 300 can tip or rotate upward toward a horizontal configuration, as indicated by arrow D. During the pivoting actions, pin 340 can rotate within slot 222.

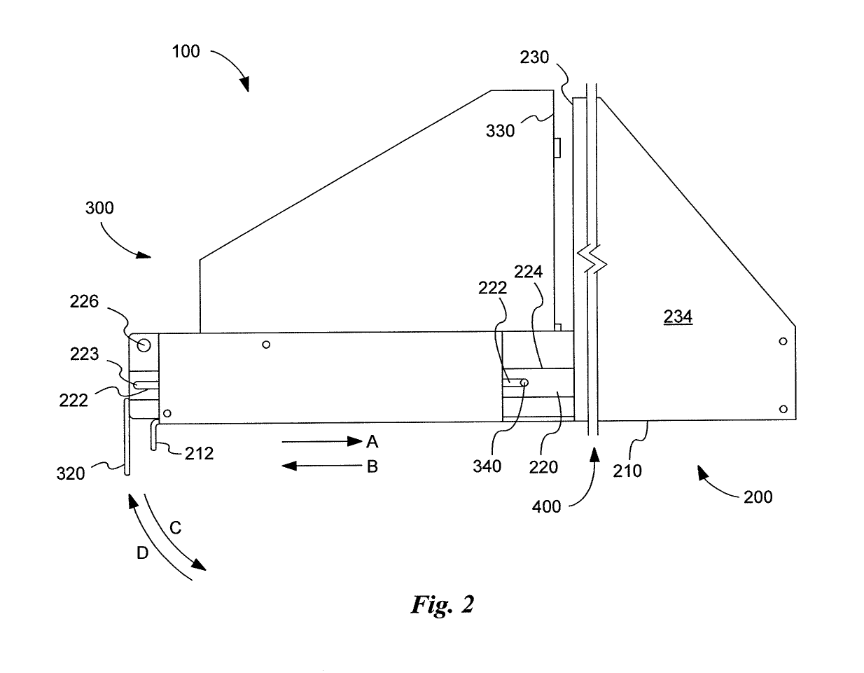

FIG. 2 depicts a side view of shelf assembly 100 according to embodiments of the present invention. Shelf assembly 100 includes a support mechanism 200 in operative association with a pivoting tray mechanism 300. Support mechanism 200 is typically coupled with one or more vertical mounting rails 400. As shown here, support mechanism 200 may include a shelf 210 having an anterior lip 212, support rails 220, and mounting connections 230 having a side plate 234. As shown here, a support rail 220 can be coupled with a vertical mounting rail 400, or another component of a protective container, via a mounting connection 230. A support rail 220 can include a translation slot 222, a tray engagement flange 224, and a locking aperture 226. In some cases, mounting connection 230 is directly attached with mounting rail 400.

Pivoting tray mechanism 300 can include a component tray having an anterior lip or handle 320, component connections 330, pins 340, rail engagement flanges (not shown), and locking pins (not shown). In use, tray mechanism 300 can translate relative to support mechanism 200. For example, tray mechanism 300 can slide toward a posterior location as indicted by arrow A. Similarly, tray mechanism 300 can slide toward an anterior location as indicated by arrow B. Optionally, a user or operator can effect such translation by grasping and either pulling or pushing on handle 320. During translation, pin 340 can slide along and within translation slot 222. In the embodiment depicted in FIG. 2, tray mechanism 300 is shown in a retracted position. When in an extended position, tray mechanism can pivot relative to support mechanism 200. For example, tray mechanism 300 can tip or rotate downward toward a vertical orientation, as indicated by arrow C. Similarly, tray mechanism 300 can tip or rotate upward toward a horizontal configuration, as indicated by arrow D. During the pivoting actions, pin 340 can rotate within an anterior portion 223 of slot 222.

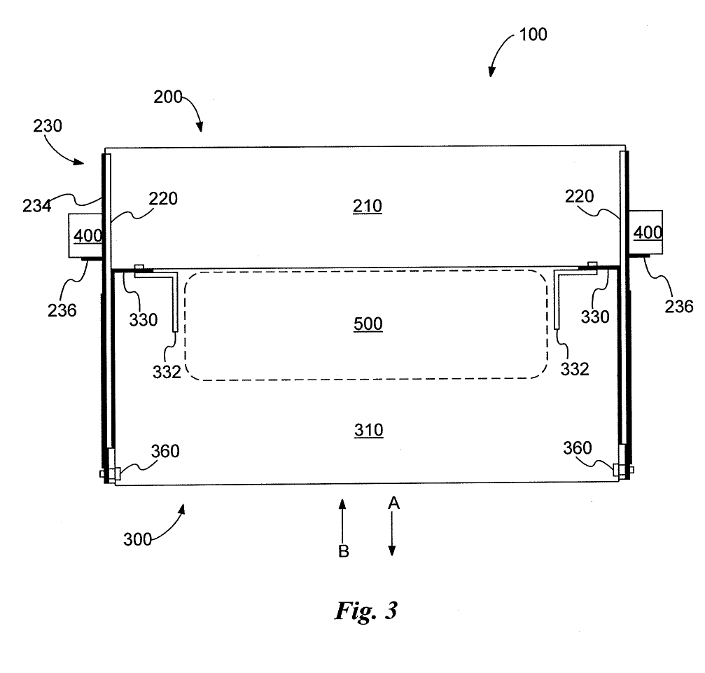

FIG. 3 depicts a top view of shelf assembly 100 according to embodiments of the present invention. Shelf assembly 100 includes a support mechanism 200 in operative association with a pivoting tray mechanism 300. Support mechanism 200 is typically coupled with one or more vertical mounting rails 400. As shown here, support mechanism 200 may include a shelf 210 and mounting connections 230 having a side plate 234 and front plate 236. As shown here, a support rail 220 can be coupled with a vertical mounting rail 400, or another component of a protective container, for example via a side plate 234 or a front plate 236 of mounting connection 230. In some cases, mounting connection 230 is directly attached with mounting rail 400.

Pivoting tray mechanism 300 can include a component tray 310, component connections 330, and locking pins 360. In use, tray mechanism 300 can translate relative to support mechanism 200. For example, tray mechanism 300 can slide toward a posterior location as indicted by arrow A. Similarly, tray mechanism 300 can slide toward an anterior location as indicated by arrow B. Optionally, a user or operator can effect such translation by grasping and either pulling or pushing on an anterior portion 312 of tray 310. In the embodiment depicted in FIG. 3, tray mechanism 300 is shown in a refracted position. When in an extended position, tray mechanism can pivot relative to support mechanism 200. As shown here, an electronic component 500, such as a router, can be coupled with tray mechanism 300. For example, electronic component 500 can be coupled with component connections 330, optionally via component brackets 332. Shelf assemblies according to embodiments of the present invention are well suited for use with a variety of electronic or telecommunications components, including without limitation power distribution units, dispersion compensation modules, amplifiers, duplexers, multiplexers, demultiplexers, transceivers, muxceivers, combiners, antennas, alarms, controllers, processors, computers, and the like.

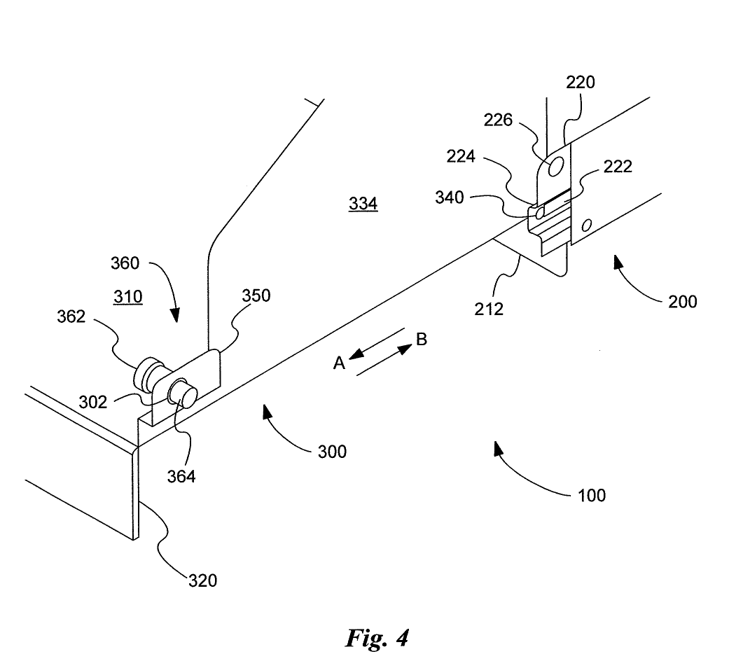

FIG. 4 shows aspects of a shelf assembly 100 according to embodiments of the present invention. Shelf assembly 100 includes a support mechanism 200 in operative association with a pivoting tray mechanism 300. Support mechanism 200 may include a shelf having an anterior lip 212, and support rails 220 having a translation slot 222, a tray engagement flange 224, and a locking aperture 226. Pivoting tray mechanism 300 can include a component tray 310, an anterior lip or handle 320, component connections having side plates 334, pins 340, rail engagement flanges 350, and locking pins 360. As shown here, locking pin 360 may include a head 362 and a shaft 364. In use, tray mechanism 300 can translate relative to support mechanism 200. For example, tray mechanism 300 can slide toward a posterior location as indicted by arrow A. Similarly, tray mechanism 300 can slide toward an anterior location as indicated by arrow B. Optionally, a user or operator can effect such translation by grasping and either pulling or pushing on handle 320. During translation, pin 340 can slide along and within translation slot 222. In the embodiment depicted in FIG. 1, tray mechanism 300 is shown in an extended position. When in a retracted position, rail engagement flange 350 can engage or rest upon tray engagement flange 224, and locking pin shaft 364 can be translated or moved within a pin aperture 302 of tray mechanism 300.

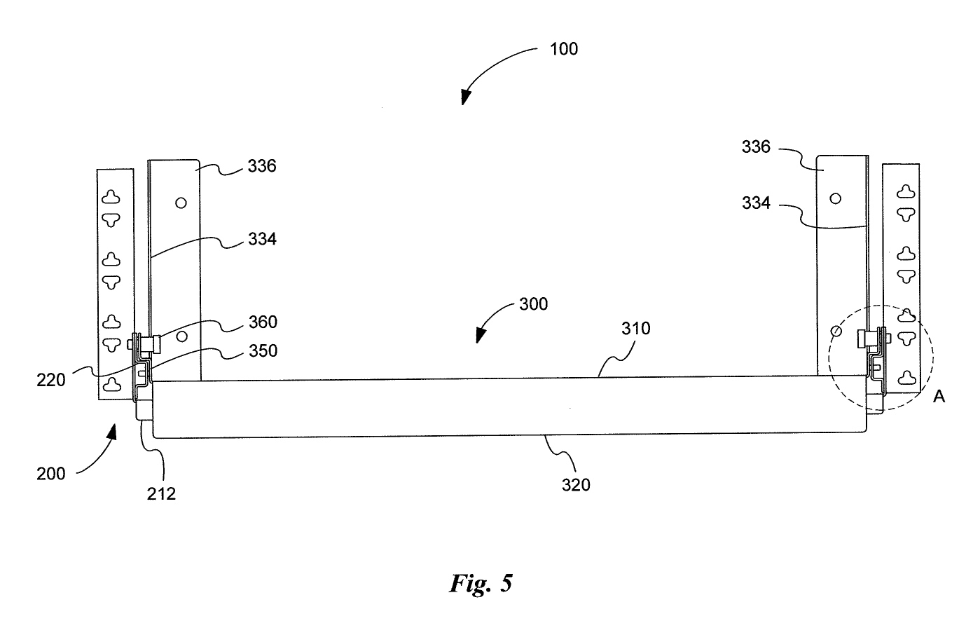

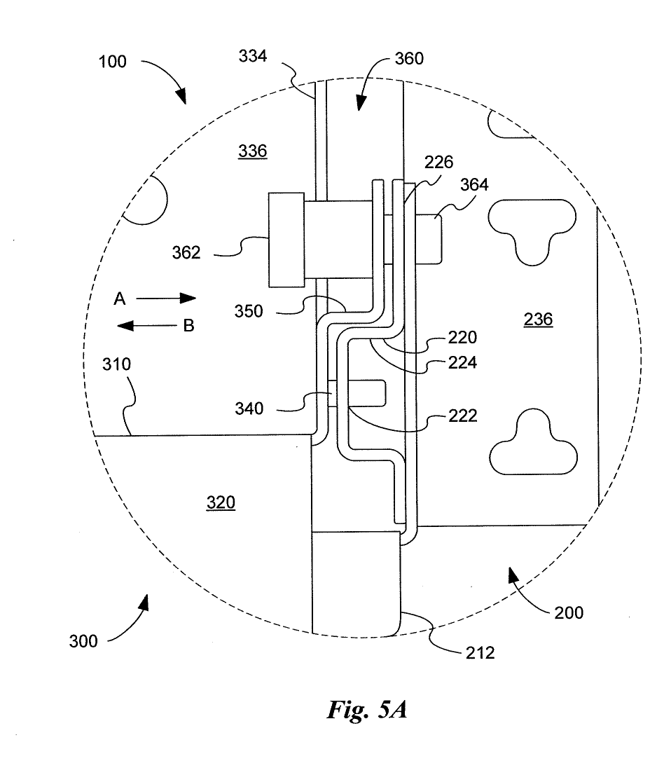

FIG. 5 shows aspects of a shelf assembly 100 according to embodiments of the present invention. Shelf assembly 100 includes a support mechanism 200 in operative association with a pivoting tray mechanism 300. Support mechanism 200 may include a shelf having an anterior lip 212, and support rails 220 having a translation slot, a tray engagement flange, and a locking aperture. Pivoting tray mechanism 300 can include a component tray 310, an anterior lip or handle 320, component connections having side plates 334 and rear plates 336, pins 340, rail engagement flanges 350, and locking pins 360. FIG. 5A provides a detail of the area indicated by region A of FIG. 5. As depicted in FIG. 5A, Shelf assembly 100 includes a support mechanism 200 in operative association with a pivoting tray mechanism 300. Support mechanism 200 may include a shelf having an anterior lip 212, and support rails 220 having a translation slot 222, a tray engagement flange 224, and a locking aperture 226. Support rail 220 may be coupled with a vertical mounting rail of a protective enclosure, for example via a front plate 236 of a mounting connection. Pivoting tray mechanism 300 can include a component tray 310, an anterior lip or handle 320, a component connection having a side plate 334 and a rear plate 336, a pin 340, a rail engagement flange 350, and a locking pin 360. As shown here, locking pin 360 may include a head 362 and a shaft 364. When tray mechanism 300 is in a retracted position, rail engagement flange 350 can engage or rest upon tray engagement flange 224, and locking pin shaft 364 can be translated or moved within a pin aperture 302 of tray mechanism 300, such that locking pin 360 extends into locking aperture 226. When locking pin 360 is inserted or advanced into locking aperture 226, for example in the direction indicated by arrow A, pivoting tray mechanism 300 becomes fixed relative to support mechanism 200. For example, rail engagement flange 350 cannot translate or move relative to tray engagement flange 224. In this sense, locking pin 360 can be used to lock the orientation of tray mechanism 300. Conversely, when locking pin 360 is removed or retracted from locking aperture 226, for example in the direction indicated by arrow B, pivoting tray mechanism 300 is free to move relative to support mechanism 200. For example, rail engagement flange 350 can translate or move relative to tray engagement flange 224. In this sense, locking pin 360 can be switched to unlock the orientation of tray mechanism 300.

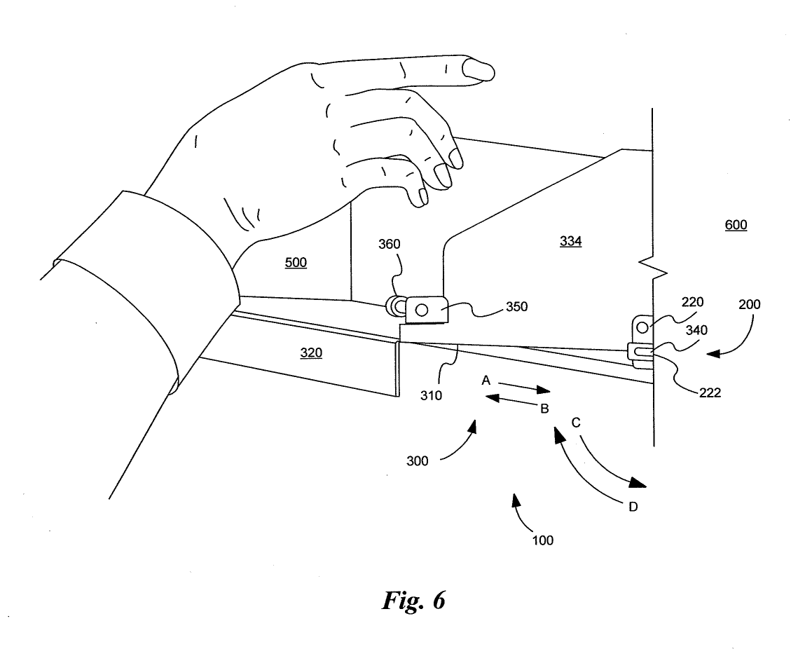

FIG. 6 shows aspects of a shelf assembly 100 according to embodiments of the present invention. Shelf assembly 100 includes a support mechanism 200 in operative association with a pivoting tray mechanism 300. Support mechanism 200 may include a support rail 220 that is fixed relative to a vertical mounting rail or cabinet enclosure 600. Support rail 220 may include a translation slot 222. In some cases, support rail is coupled directly to cabinet enclosure 600. Pivoting tray mechanism 300 can include a component tray 310, an anterior lip or handle 320, a component connection having a side plate 334, a translation pin 340, a rail engagement flange 350, and a locking pin 360. In use, an operator may push or pull a tray mechanism 300, or an electronic component 500 that is coupled with tray mechanism 300, thereby causing tray mechanism 300 to translate relative to support mechanism 200. For example, tray mechanism 300 can slide toward a posterior location as indicted by arrow A. Similarly, tray mechanism 300 can slide toward an anterior location as indicated by arrow B. Optionally, a user or operator can effect such translation by grasping and either pulling or pushing on an anterior portion of tray 310. In the embodiment depicted in FIG. 6, tray mechanism 300 is shown in an extended position. When in an extended position, tray mechanism can pivot relative to support mechanism 200. For example, tray mechanism 300 can tip or rotate downward toward a vertical orientation, as indicated by arrow C. Similarly, tray mechanism 300 can tip or rotate upward toward a horizontal configuration, as indicated by arrow D. During the pivoting actions, pin 340 can rotate within an anterior portion of slot 222.

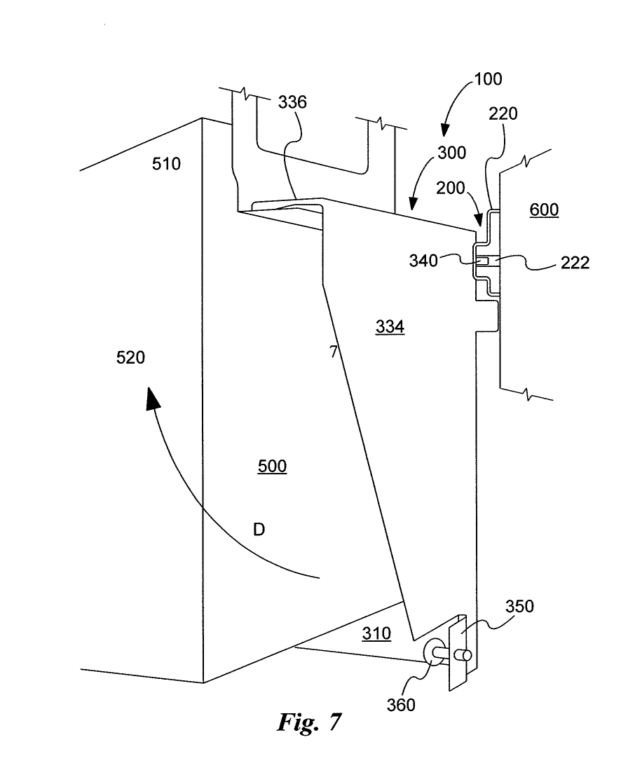

FIG. 7 shows aspects of a shelf assembly 100 according to embodiments of the present invention. Shelf assembly 100 includes a support mechanism 200 in operative association with a pivoting tray mechanism 300. Support mechanism 200 may include a support rail 220 that is fixed relative to a vertical mounting rail or cabinet enclosure 600. Support rail 220 may include a translation slot 222. In some cases, support rail is coupled directly to cabinet enclosure 600. Pivoting tray mechanism 300 can include a component tray 310, a component connection having a side plate 334 and a rear plate 336, a translation pin 340, a rail engagement flange 350, and a locking pin 360. In the embodiment depicted in FIG. 7, tray mechanism 300 is shown in an extended position, and tray 310 is pivoted in a downward or vertically oriented position. When tray 310 is in this configuration, a rear portion 510 of the electronic component 500 is outside of or toward the front of the cabinet enclosure 600, and facing upward, thus establishing convenient access to the rear portion 510 or top portion 520 of the equipment. In this way, a technician or operator can easily attend to installation, removal, wiring, cabling, or other electronic component operations or maintenance functions. After the desired operations are complete, the tray can be tipped back to a horizontal orientation, and returned to the original position. For example, tray mechanism 300 can tip or rotate upward toward a horizontal configuration, as indicated by arrow D. During the pivoting actions, pin 340 can rotate within an anterior portion of slot 222.

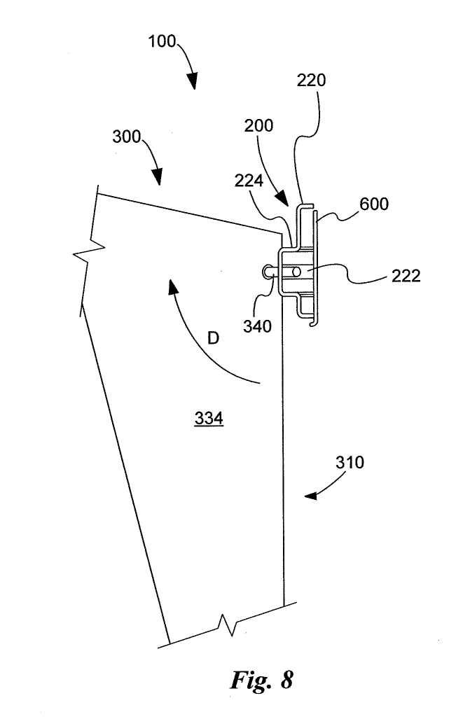

FIG. 8 shows aspects of a shelf assembly 100 according to embodiments of the present invention. Shelf assembly 100 includes a support mechanism 200 in operative association with a pivoting tray mechanism 300. Support mechanism 200 may include a support rail 220 that is fixed relative to a vertical mounting rail or cabinet enclosure 600. Support rail 220 may include a translation slot 222 and a tray engagement flange 224. Pivoting tray mechanism 300 can include a component tray 310, a component connection having a side plate 334 and a rear plate 336, and a translation pin 340. In the embodiment depicted in FIG. 7, tray mechanism 300 is shown in an extended position, and tray 310 is pivoted in a downward or vertically oriented position. When tray 310 is in this configuration, a rear portion of an electronic component is outside of or toward the front of the cabinet enclosure 600, and facing upward, thus establishing convenient access to the rear 510 of the equipment. In this way, a technician or operator can easily attend to installation, removal, wiring, cabling, or other electronic component operations or maintenance functions. After the desired operations are complete, the tray can be tipped back to a horizontal orientation, and returned to the original position. For example, tray mechanism 300 can tip or rotate upward toward a horizontal configuration, as indicated by arrow D. During the pivoting actions, pin 340 can rotate within an anterior portion of slot 222.

Although certain system, device, and method embodiments have been disclosed herein, it will be apparent from the foregoing disclosure to those skilled in the art that variations, modifications, alternative constructions, and equivalents of such embodiments may be made without departing from the true spirit and scope of the invention. Therefore, the above description should not be taken as limiting the scope of the invention which is defined by the appended claims.

What is claimed is:

1. A telecommunications cabinet system, comprising:
a cabinet enclosure; and
a tippable shelf assembly comprising:
a support mechanism comprising a mounting connection for coupling with the telecommunication cabinet; and
a pivoting tray mechanism comprising a component connection for attachment with a telecommunications component, the pivoting tray mechanism pivotably and translatably coupled with the support mechanism,
wherein the mounting connection of the support mechanism of the tippable shelf assembly is coupled with the cabinet enclosure.

2. The telecommunications cabinet system according to claim 1, wherein the cabinet enclosure comprises a mounting rail, and the mounting connection of the support mechanism of the tippable shelf assembly is coupled with the mounting rail.

3. The telecommunications cabinet system according to claim 2, wherein the mounting rail is disposed in a vertical orientation.

4. The telecommunications cabinet system according to claim 1, wherein the support mechanism comprises a support rail having a translation slot, and the pivoting tray mechanism comprises a pin engaged with the support rail translation slot.

5. The telecommunications cabinet system according to claim 1, wherein the support mechanism comprises a support locking member, and the pivoting tray mechanism comprises a pivoting tray locking member that locks with the support locking member.

6. The telecommunications cabinet system according to claim 5, wherein the support locking member comprises a locking aperture, and the pivoting tray locking member comprises a locking pin.

7. The telecommunications cabinet system according to claim 1, wherein the pivoting tray mechanism comprises a rail engagement flange, and the support mechanism comprises a support rail that supports the rail engagement flange.

8. The telecommunications system according to claim 7, wherein the support rail of the support mechanism comprises a support locking member, and the pivoting tray mechanism comprises a pivoting tray locking member that locks with the support locking member.

9. A tippable shelf assembly for use in a telecommunication cabinet, the shelf assembly comprising:
a support mechanism comprising a mounting connection for coupling with the telecommunication cabinet; and
a pivoting tray mechanism comprising a component connection for attachment with a telecommunications component,
wherein the pivoting tray mechanism is pivotably and translatably coupled with the support mechanism.

10. The tippable shelf assembly according to claim 9, wherein the support mechanism comprises a support rail having a translation slot, and the pivoting tray mechanism comprises a pin engaged with the support rail translation slot.

11. The tippable shelf assembly according to claim 9, wherein the support mechanism comprises a support locking member, and the pivoting tray mechanism comprises a pivoting tray locking member that locks with the support locking member.

12. The tippable shelf assembly according to claim 11, wherein the support locking member comprises a locking aperture, and the pivoting tray locking member comprises a locking pin.

13. The tippable shelf assembly according to claim 9, wherein the pivoting tray mechanism comprises a rail engagement flange, and the support mechanism comprises a support rail that supports the rail engagement flange.

14. The tippable shelf assembly according to claim 13, wherein the support rail of the support mechanism comprises a support locking member, and the pivoting tray mechanism comprises a pivoting tray locking member that locks with the support locking member.

15. A method of installing a telecommunications component in a telecommunications cabinet system, the method comprising:
positioning a tippable shelf assembly in an enclosure of the telecommunications cabinet system, wherein the tippable shelf assembly comprises a support mechanism having a mounting connection for coupling with the telecommunication cabinet, and a pivoting tray mechanism having a component connection for attachment with a telecommunications component, and wherein the pivoting tray mechanism is pivotably and translatably coupled with the support mechanism;
coupling the mounting connection of the tippable shelf assembly support mechanism with the telecommunication cabinet; and
coupling the component connection of the pivoting tray mechanism with the telecommunications component.

16. The method according to claim 15, wherein the step of coupling the mounting connection of the tippable shelf assembly support mechanism with the telecommunication cabinet comprises coupling the mounting connection with a vertical mounting rail of the telecommunication cabinet.

17. A method of accessing a telecommunications component stored in a telecommunications cabinet, the method comprising:
translating a pivoting tray mechanism relative to a support mechanism toward an opening of the telecommunications cabinet, wherein the pivoting tray mechanism is pivotably and translatably coupled with the support mechanism, the support mechanism is coupled with the telecommunications cabinet, and the telecommunications component is coupled with the pivoting tray mechanism;
tipping an anterior portion of the pivoting tray mechanism in a downward direction; and
accessing a portion of the telecommunications component.

18. The method according to claim 17, wherein the pivoting tray mechanism comprises a pin and the support mechanism comprises a support rail having a translation slot, and wherein the step of translating the pivoting tray mechanism comprises translating the pin of the pivoting tray mechanism within the translation slot of the support rail.

19. The method according to claim 17, wherein the pivoting tray mechanism comprises a pin and the support mechanism comprises a support rail having a translation slot, and wherein the step of tipping the anterior portion of the tray mechanism comprises rotating the pin of the pivoting tray mechanism within the translation slot of the support rail.

20. The method according to claim 17, wherein the support mechanism comprises a support locking member, the pivoting tray mechanism comprises a pivoting tray locking member that locks with the support locking member, and wherein the method further comprises unlocking the pivoting tray locking member from the support locking member.
